(19) United States
(12) Patent Application Publication
(10) Pub. No.: US 2016/0093282 A1
(43) Pub. Date: Mar. 31, 2016

(54) METHOD AND APPARATUS FOR ACTIVE NOISE CANCELLATION WITHIN AN ENCLOSED SPACE

(71) Applicant: Sina MOSHKSAR, Victoria (CA)

(72) Inventor: Sina MOSHKSAR, Victoria (CA)

(21) Appl. No.: 14/867,602

(22) Filed: Sep. 28, 2015

Related U.S. Application Data
(60) Provisional application No. 62/056,993, filed on Sep. 29, 2014.

(51) Int. Cl. G10K 11/178

(52) U.S. Cl. CPC G10K 11/1784; G10K 11/1786; G10K 2210/12; G10K 2210/3215; G10K 2210/3218; G10K 2210/3226

(57) ABSTRACT

A method of active noise cancellation and an associated system for cancelling noise within an enclosed space are described. The method involves detecting acoustic noise outside of the enclosed space. The method then involves generating a noise cancellation signal outside of the enclosed space, such that the acoustic noise is cancelled prior to the acoustic noise entering the enclosed space.

### FIELD

This invention relates to a method and system for active noise cancellation. Particularly, this invention relates to a novel technique for the active control of noise in an enclosed space, such as a room. The invention is applicable to rooms in houses, commercial buildings, hospitals, restaurants, schools, universities and other buildings.

### BACKGROUND

Conventional noise cancelation methods and systems used in buildings usually come in either active or passive types. The passive approach is about sound insulation of houses and other structures mostly effective for high frequency. In this method each individual window and exterior door is insulated or built out of special materials in order to reduce noise entering the building. However, since special materials and technicians are required for the soundproofing of each house, it is very costly. Moreover, these techniques do not work when door or windows are opened.

Active Noise Cancelation systems (ANC) for free and enclosed spaces are designed explicitly to minimize the sum of the noise power at finite number of spatial points. It operates on the premise that attenuating noise at a finite number of spatial points within a room will result in attenuation of the noise at all other points of interest.

### SUMMARY

According to one aspect, there is provided a method of active noise cancellation for cancelling noise within an enclosed space. The method involves detecting acoustic noise outside of the enclosed space. The method then involves generating a noise cancellation signal outside of the enclosed space, such that the acoustic noise is cancelled prior to the acoustic noise entering the enclosed space.

The premise behind this method is that once the acoustic noise enters the enclosed spaced, it is too late. In order to insulate the enclosed space from outside acoustic noise, the acoustic noise must be cancelled before it enters the enclosed space.

According to another aspect there is provided an active noise cancellation system for cancelling noise within an enclosed space. The system includes at least one microphone, a processor and at least one sound emitter. The microphone is positioned outside of the enclosed space. The processor receives input from the microphone and computes a noise cancellation signal. The sound emitter receives instructions from the processor and generates the noise cancellation signal. The sound emitter is positioned outside of the enclosed space, such that acoustic noise detected by the at least one microphone is cancelled prior to the acoustic noise entering the enclosed space.

It is envisaged that for many applications, the enclosed space will be a room. It is envisaged that active noise cancellation of unwanted acoustic noise will take place at points of entry into the room. A common point of entry for unwanted acoustic noise into a room is a window. In such cases, the microphone will be positioned outside of the window through which the unwanted acoustic noise enters.

It will be appreciated that improved performance can be obtained from the system when an array of microphones are used, along with an array of sound emitters.

There will hereinafter be described two embodiments. A first embodiment has one or more reference microphones to detect incoming noise prior to the noise cancellation signal being generated and one or more verification microphones to verify the effectiveness of the noise cancellation signal in cancelling the incoming noise. The verification microphones are positioned between the enclosed space (such as a room) and the loudspeakers. This is to ensure that the verification microphones are not exposed to and influenced by the noise cancellation signal. A second embodiment uses only verification microphones to both detect incoming noise prior to the noise cancellation signal being generated and to verify the effectiveness of the noise cancellation signal in cancelling the incoming noise.

It may be essential that selected sound frequencies (for example fire alarms), be still audible to occupants of a room. It will be appreciated that the active noise cancellation can be “tuned” to allow selected sound frequencies to pass without cancellation.

This innovation will use active control approach to cancel the noise. Active noise control techniques aim to reduce acoustic levels by the addition of a second sound specifically designed to cancel the noise. This involves one or more noise-cancellation sound emitters (loudspeakers) emitting a sound wave with the same amplitude but with inverted phase to the original sound. The waves combine to form a new wave, in a process called interference and effectively cancel each other out.

The novelty of this invention centers around the innovative installation of active noise cancelation system for buildings. In this invention windows are considered as the entry points of noise into rooms. The system cancels the noise just outside of the window before noise gets into the room.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a first embodiment of active noise cancelation system.

FIG. 2 is top plan view of the first embodiment of active noise cancellation system illustrated in FIG. 1.

FIG. 3 is a side elevation view of a second embodiment of active noise cancellation system.

FIG. 4 is top plan view of the second embodiment of active noise cancellation system illustrated in FIG. 4.

### DETAILED DESCRIPTION

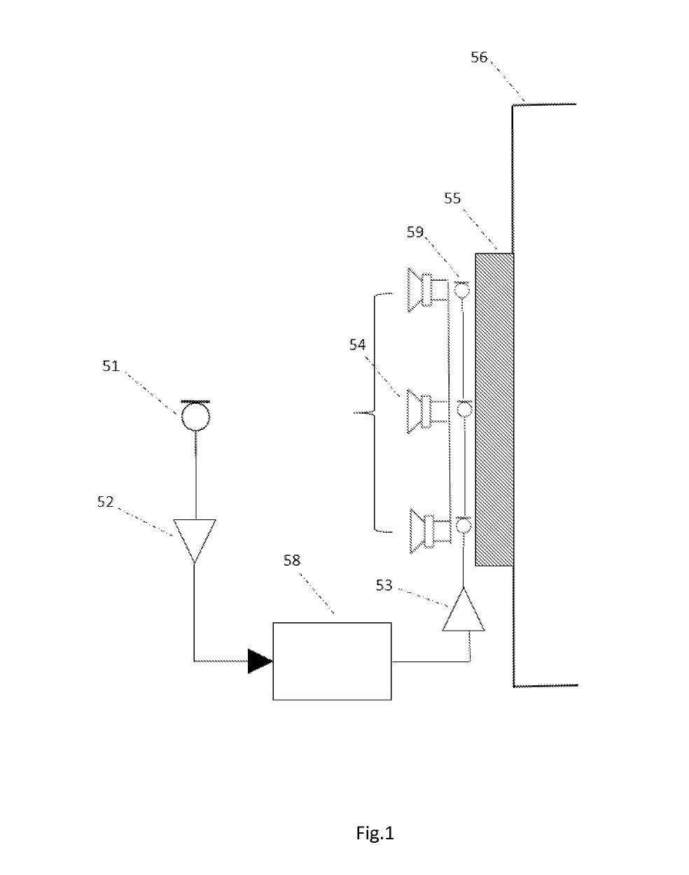

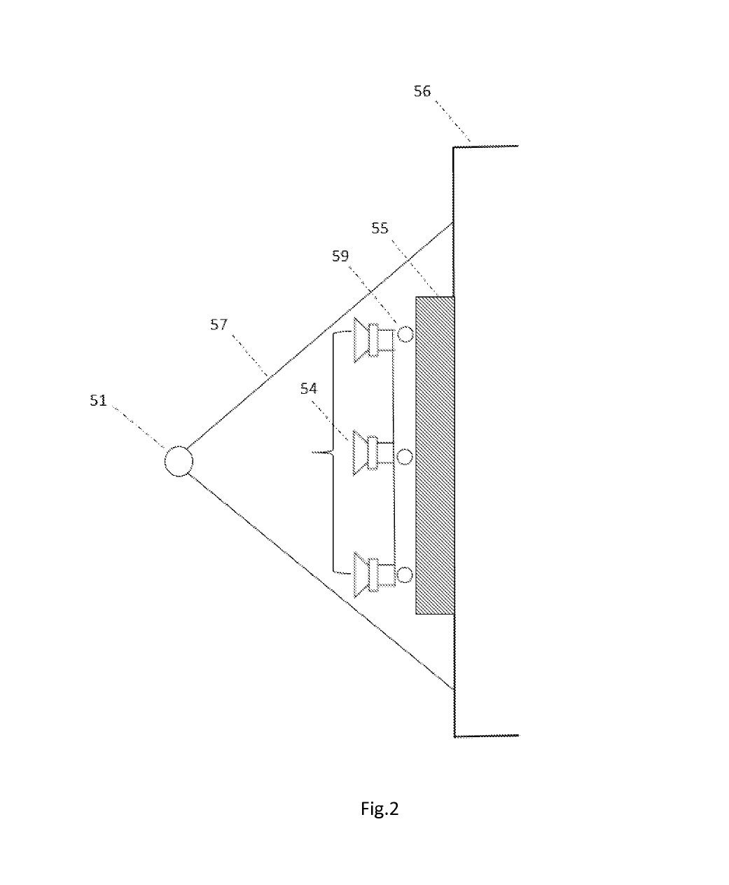

A first embodiment of active noise cancellation system will be described with reference to FIG. 1 and FIG. 2.

### Structure and Relationship of Parts:

Referring to FIG. 1 and FIG. 2, the silence machine comprises: a reference microphone 51, a pre-Amplifier 52, a power Amplifier 53, a sound emitter (an array of loudspeakers 54 is shown), a window 55, a room 56, microphone support bars 57 and processor 58. Processor 58 is one that is commercially available for designing and simulating process signals and is sold under the Trademark “DSP System”. Reference microphone 51 is mounted in front of window 56. Loudspeakers 54 is mounted to the window frame. As will hereinafter be further described, reference microphone 51 is for measuring ambient noise. The processor receives input from reference microphone 51 and determines a signal that is 180 degrees out of phase with the intruding acoustic sound waves. Loudspeakers 54 are sound emitters for producing the anti-noise sound to cancel the original intruding acoustic noise. In order to determine the effectiveness of the sound cancellation, at least one and preferably several verification microphones 59 are provided that also provide sensing data to processor 58. It is to be noted that verification microphone 59 is positioned between the enclosed space (room 56) and loudspeakers 54. With this positioning, verification microphone 59 is not exposed to the noise cancellation signal and can, therefore, better detect incoming noise that reaches room 56 notwithstanding the noise cancellation signal.

### Operation:

The above described active noise cancellation system creates its own sound waves that mimic the incoming noise in every respect except one: the speaker's sound waves are 180 degrees out of phase with the intruding waves. The reference microphone 51 measures the acoustic noise signal outside of the enclosed space, in this case room 56. I preferred position for positioning reference microphone 51 is at a point of entry of unwanted acoustic noise, in this case window 55. Processor 58 is continually receiving input from reference microphone 51 and adaptively follows the changes in noise spectrum and produces an “anti-noise” signal which destructively interferes with the original sound and cancels out the original sound. Array of loud speakers, 54, produces anti-noise sound in response to an input signal from processor 58. It will be appreciated that, an array of microphones may be used depending upon the dimensions of the point of entry (ie. size of window 55). The object is to prevent intruding acoustic sounds for entering room 56 through window 55. The verification microphones 59 are positioned between loudspeakers 54 and window 55. Verification microphones 59 do not receive and are not influenced by the cancellation signal emitted by loudspeakers 54. Verification microphones 59 are intended to detect what incoming noise remains after active noise cancellation. This enables processor 58 to modify or intensify the cancellation signal, as may be required, depending upon what level of sound cancellation is intended.

### Advantages:

The above described method and active noise cancellation system provides protection again environmental noise that may harm the activity or balance of human or animal life. It can be deployed to prevent noise from entering any enclosed space. One possible application is to provide comfort to the patients in the hospitals. Another possible application is to provide an enhanced learning environment in schools. Yet another possible application is to provide a better working environment, so that there is less work stress and better productivity of workers.

Once the system is implemented, it is possible to make a real time map of noise pollution in an area based on the information from each individual system. Power saving features can be incorporated by defining an acoustic threshold or turning on and off the system based upon pre-set parameters. For example for an office building, the system may only operate during business hours when the building is normally occupied and the system may be dormant during non-business hours and on weekends. There is an ability to pass without cancellation specific frequencies, such as the alarm. The system can be set up with a smart phone application, such that system settings can be changed by smart phones.

Computer modelling was conducted to determine the effectiveness of the above described method of active noise cancellation. The modelling was conducted with a window having a width of 50 centimeters and incoming noise in the 600 Hertz range. It was determined that noise cancellation of approximately 80% was achieved. It is appreciated that this was a computer model and not an actual installation. However, it is anticipated that like results may be obtained in an actual installation. Once beneficial results are obtained in an actual installation, it will be a matter of optimizing techniques to obtain even more beneficial results with an even higher percentage of cancellation.

### Variations:

It will be appreciated that when an array of speakers are provided to increase an area of coverage, the speakers can be mounted vertically, mounted horizontally or forming a grid pattern. Similarly, it will be appreciated that when an array of microphones are provided to increase an area of coverage, the microphones can be mounted vertically, mounted horizontally or forming a grid pattern. It will be appreciated that an array of verification microphones may be provided to provide feedback on the effectiveness of the noise cancellation.

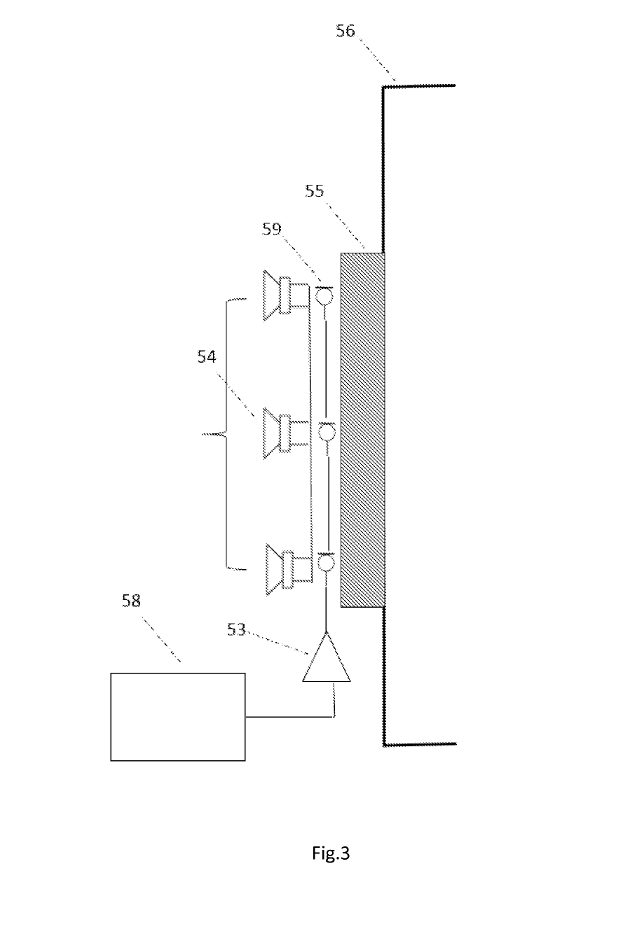

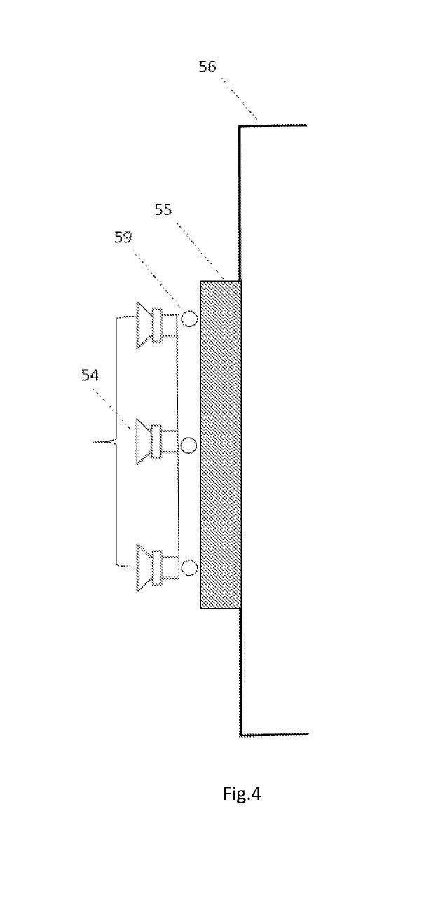

In the preferred embodiment, incoming noise is detected by one or more reference microphones 51. The information regarding incoming noise is used by processor 58 to cause loudspeakers 54 to generate a cancellation signal. After active noise cancellation has been attempted, the results of the active noise cancellation are then verified by one or more verification microphones 59. Referring to FIG. 3 and FIG. 4, there is illustrated a second embodiment. In the second embodiment, the identical components have being identified by the same reference numerals as were used to describe the components for the first embodiment. In this second embodiment, there are no reference microphones 51. The reason for this is that the second embodiment uses verification microphones 59 to perform the combined function of detecting incoming noise prior to the sending of the noise cancellation signal and verification of the effectiveness of the noise cancellation signal has been sent. The advantage of the second embodiment is that it is more compact. A possible disadvantage of the second embodiment is that it may not be as accurate as the first embodiment which has one or more reference microphones. Until a side by side comparison is made of an actual installation of the first embodiment and an actual installation of the second embodiment the relative accuracy can only be speculated.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. An active noise cancellation system for cancelling noise within an enclosed space, comprising:
at least one microphone for detecting acoustic noise, the at least one microphone being positioned outside of the enclosed space;
a processor receiving input from the microphone and computing a noise cancellation signal; and
at least one sound emitter receiving instructions from the processor and generating the noise cancellation signal, the at least one sound emitter being positioned outside of the enclosed space, such that acoustic noise detected by the at least one microphone is cancelled prior to the acoustic noise entering the enclosed space.

2. The active noise cancellation system of claim 1, wherein more than one microphone is provided to detect incoming noise prior to the noise cancellation signal being generated.

3. The active noise cancellation system of claim 1, wherein the at least one microphone is positioned between the enclosed space and the loudspeakers, such that the at least one microphone is not, exposed to the noise cancellation signal.

4. The active noise cancellation system of claim 1, wherein more than one microphone is provided including at least one reference microphone to detect incoming noise prior to the noise cancellation signal being generated and at least one verification microphone to verify the effectiveness of the noise cancellation signal in cancelling the incoming noise.

5. The active noise cancellation system of claim 4, wherein the at least one verification microphone is positioned between the enclosed space and the loudspeakers, such that the at least one verification microphone is not exposed to the noise cancellation signal.

6. The active noise cancellation system of claim 1, wherein the enclosed space is a room.

7. The active noise cancellation system of claim 1, wherein the at least one microphone is positioned at a point of entry to the enclosed space.

8. The active noise cancellation system of claim 7, wherein the point of noise entry is a window through which noise enters and the at least one microphone is positioned outside of the window.

9. The active noise cancellation system of claim 4, wherein there is an array of reference microphones.

10. The active noise cancellation system of claim 4, wherein there is an array of verification microphones.

11. The active noise cancellation system of claim 1, wherein there is an array of sound emitters.

12. The active noise cancellation system of claim 1, wherein the processor is programmed to permit selected sound frequencies to pass without cancellation.

13. The active noise cancellation system of claim 1, wherein the processor is programmed to remain dormant without implementing noise cancellation until a pre-set acoustic threshold is reached.

14. The active noise cancellation system of claim 1, wherein the processor is programmed to only operate generating a noise cancellation signal between at specified times and is programmed to remain dormant without implementing noise cancellation at other times.

15. A method of active noise cancellation system for cancelling noise within an enclosed space, comprising:
detecting incoming acoustic noise outside of the enclosed space; and
generating a noise cancellation signal outside of the enclosed space, such that incoming acoustic noise is cancelled prior to the incoming acoustic noise entering the enclosed space.
